(19) United States
(12) Patent Application Publication
(10) Pub. No.: US 2026/0225535 A1
(43) Pub. Date: Aug. 6, 2026

(54) Side Accessed Cargo Storage System

(71) Applicant: Reese Metal Fabrication, LLC, Sandpoint, ID (US)

(72) Inventor: Matthew E. Reese, Sandpoint, ID (US)

(21) Appl. No.: 19/457,151

(22) Filed: Jan. 23, 2026

Related U.S. Application Data
(60) Provisional application No. 63/747,980, filed on Jan. 22, 2025.

(51) Int. Cl. B60R 9/06; B62D 33/04; E05D 7/00; B62D 33/023; E05C 17/00

(52) U.S. Cl. CPC B60R 9/065; B62D 33/04; E05D 7/009; B62D 33/023; E05C 17/00

(57) ABSTRACT

A storage system for a pickup truck bed includes a cargo box defining a storage compartment and having a ridgeline extending along a length of the cargo box. Two lids are hingedly attached to the ridgeline and extend toward opposing sidewalls of the cargo box, the lids being openable to provide access to the storage compartment from either side of the cargo box. At least two slides support the cargo box and are configured to couple the cargo box to the pickup truck bed such that the cargo box is movable between a stowed position within the truck bed and a deployed position extending outward from the truck bed. The cargo box may be dimensioned to fit beneath a tonneau cover and may include latches, locks, struts, and a handle to facilitate secure storage and user operation.

### CROSS-REFERENCE TO RELATED APPLICATIONS

This application claims the benefit of U.S. Provisional Application No. 63/747,980, filed January 22, 2025 the disclosure of which is incorporated by reference.

### TECHNICAL FIELD

The disclosure generally relates to the field of storage systems for the bed of a truck. Particular embodiments relate to a sliding storage system having side access for use in the bed of a pickup truck.

### BACKGROUND

Pickup truck bed storage systems are becoming more popular both in civilian and law enforcement use. Often in law enforcement use, a law enforcement officer law enforcement equipment in the bed of the pickup truck. This can include a variety of materials from the largest concern with storage in a bed of a pickup truck is to keep the materials stored in an easily assessable, organized manner. Several systems have been developed to provide such as, however many of these systems are compartmentalized to not provide access to a larger area simultaneously, and are accessed from the rear of the truck. However, this provides an issue as oncoming vehicles present a danger to law enforcement officers, in particular vehicles whose driver has either lost control or does not see the law enforcement officer. These rear access systems do not allow for convenient side access to allow a law enforcement officer to stand to the side of the vehicle in order to be able to view oncoming vehicles to spot potential danger to the officer.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

A storage system for use in the bed of a pickup truck is disclosed. The storage system includes a cargo box defining a storage compartment and having an elongate ridgeline extending along a length of the cargo box. The cargo box includes opposing sidewalls having a height lower than the ridgeline. Two lids are hingedly attached along the ridgeline and extend downward toward the sidewalls, such that the lids are selectively openable to provide access to the storage compartment from either side of the cargo box.

The cargo box is supported by at least two slides configured to couple the cargo box to the bed of the pickup truck. The slides permit the cargo box to translate between a stowed position located substantially within the truck bed and a deployed position extending outward from the truck bed, including over a lowered tailgate. In the deployed position, the lids may be opened to allow full access to the storage compartment from both lateral sides of the vehicle, thereby improving user accessibility and safety.

In certain embodiments, the cargo box is dimensioned to fit beneath a tonneau cover mounted to the pickup truck bed. The lids may be secured in a closed position by latches, which may include locking mechanisms. One or more struts may be provided to retain the lids in an open position. A handle may be mounted to a rear portion of the cargo box to facilitate manual deployment of the cargo box, and in some embodiments one or more actuators may be used to assist deployment or lid operation.

The disclosed storage system provides a sliding, side-accessible cargo solution that allows access to large or bulky items while maintaining compatibility with common truck bed covers and accessories.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a back elevation view of a preferred embodiment of the invention installed in the bed of a pickup truck.

FIG. 2 is side elevation view of the embodiment of FIG. 1 having the slide extended to extend the sliding cargo box over the lowered tailgate.

FIG. 3 is a back elevation view of the embodiment of FIGS. 1-2 having the slide extended to extend the sliding carbo box over the lowered tailgate.

FIG. 4 is the view of FIG. 2 having dimensional information regarding the box.

FIG. 5 is the view of FIG. 3 having dimensional information regarding the box.

### DETAILED DESCRIPTION OF THE DRAWINGS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

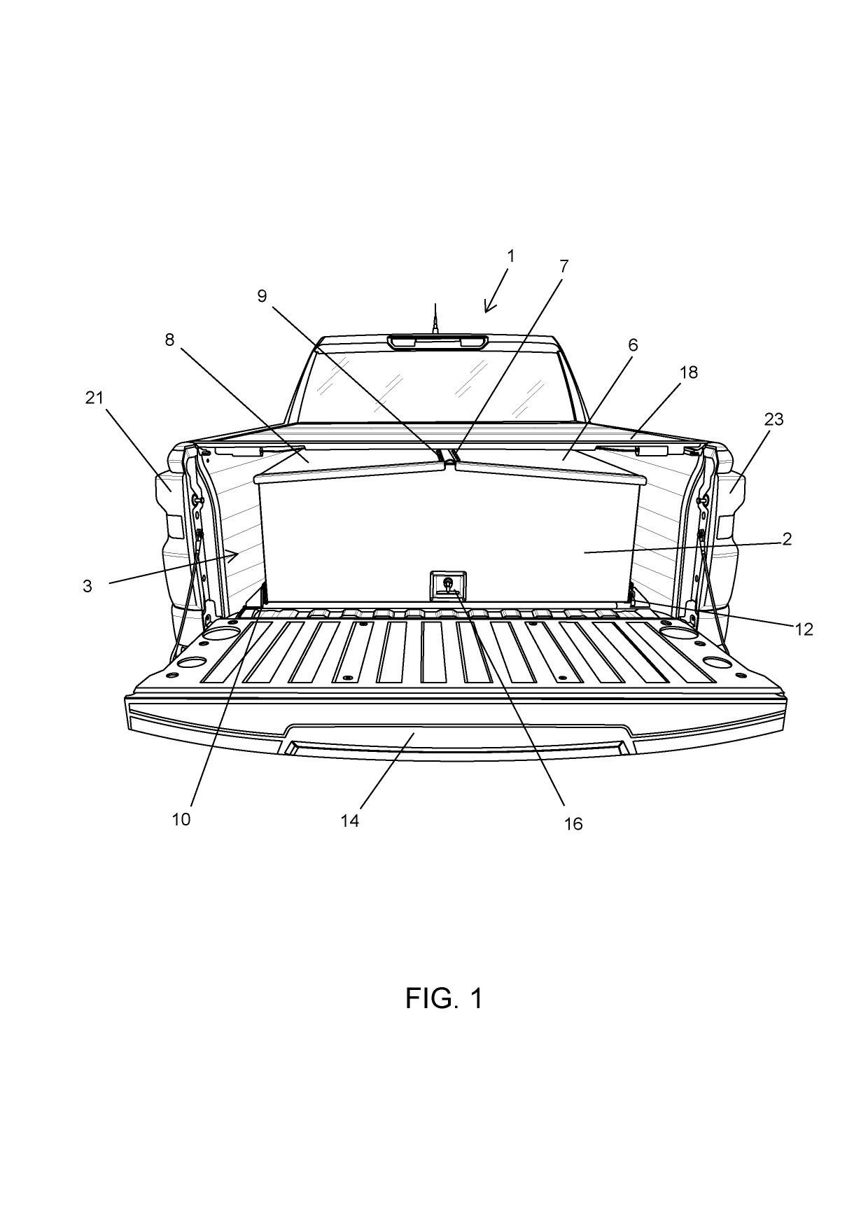

FIG. 1 illustrates a preferred embodiment of the sliding cargo box. The sliding cargo box is comprised of a box 2 having an open top with a ridgeline 4. Two lids 6, 8 are hindgedly connected to the ridgeline to provide access to the storage compartment defined by the box. A depicted vehicle of a pickup truck 1 having a bed 3. The box is attached to slides 10, 12 that allow the box to slidingly extend out of the bed 3 of the pickup truck and over the tailgate 14 of the pickup truck. The term slide in this application refers to the use of slides, such as the drawer type slides that are shown in the figures, or linear guides which can be affixed to the vehicle bed either directly or indirectly. The handle 16 is positioned on the back side of the cargo box to allow a user to grasp the box and pull to deploy the box over the tailgate. When the cargo box is fully deployed over the tailgate, a person can access the entirety of the compartment through the lids of the cargo box. This allows for full access without having to open a tonneau cover extending over the bed of the truck, as well as providing access if a camper shell or other truck bed accessory is installed over the truck bed. The ridgeline 4 has hinges 7, 9 connected to the lids of the cargo box.

The hinges allow the lids to rotationally open to provide access to the interior of the box when the box has been slid out of the bed of the truck, or to access the box over the sidewalls of the pickup truck if a tonneau cover is open or the bed is not otherwise enclosed by a shell. The depicted embodiment of the box allows for a pickup bed cover (aka tonneau cover) 18 to be used over the bed of the pickup truck such that the cargo box slides under the depicted tonneau cover and into the bed of the truck. The sliding operation of the cargo box in association with the box slides allows for the cargo box to be accessed without the user having to remove the tonneau cover. The tonneau cover protects the box to provide increased protection from theft and weather elements.

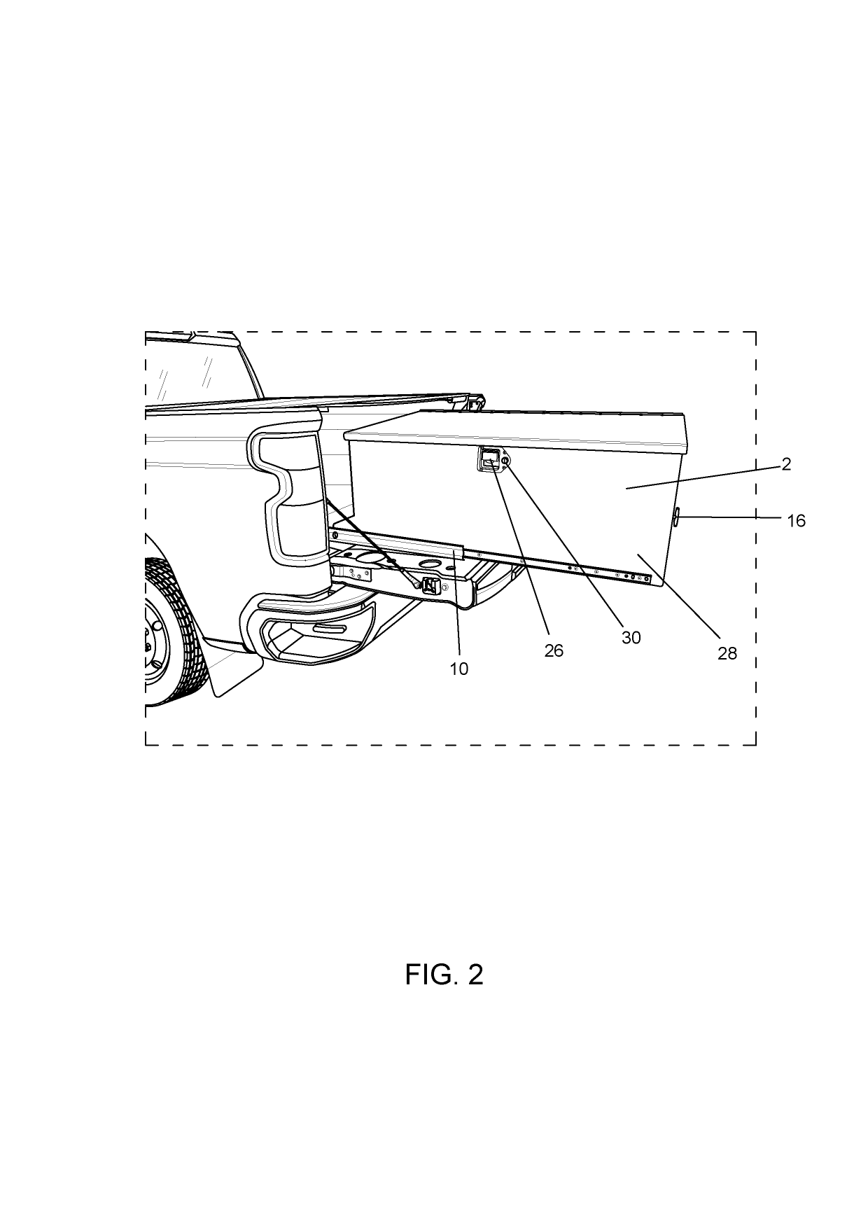

FIG. 2 depicts a side perspective view of the cargo box 2 slid out of the bed of the truck such that the box is elevated partially over the tailgate of the truck. The lids and ridgeline extend parallel to the sides 21, 23 of the bed of the truck. A latch 26 is positioned on the side wall 28 of the box. The latch is configured with lock cylinder 30 configured to lock the latch to secure the lid in a closed position.

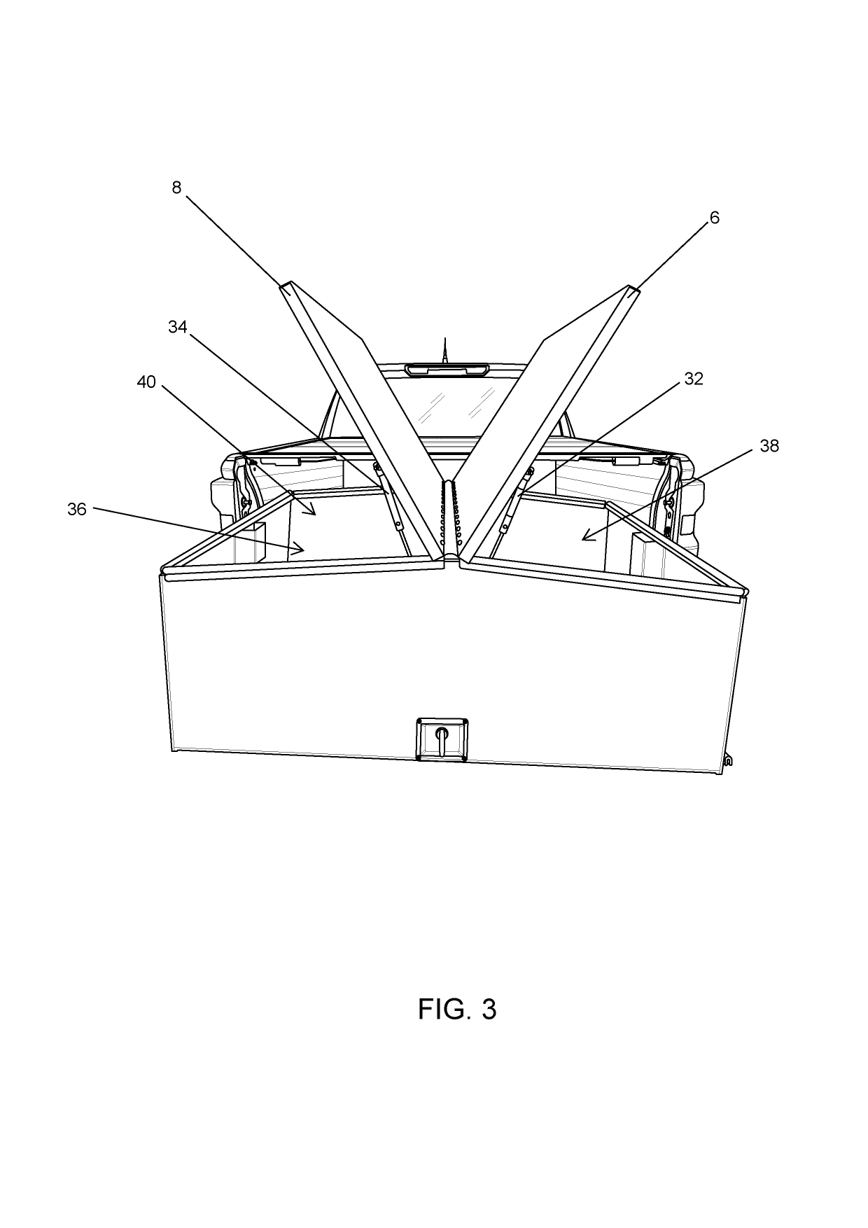

FIG. 3 illustrates the cargo box having lids 6, 8 in the open position. Struts 32, 34 are configured to retain the lids in the open position. The open lids provide access to the storage compartment 36 of the cargo box through access openings 38, 40.

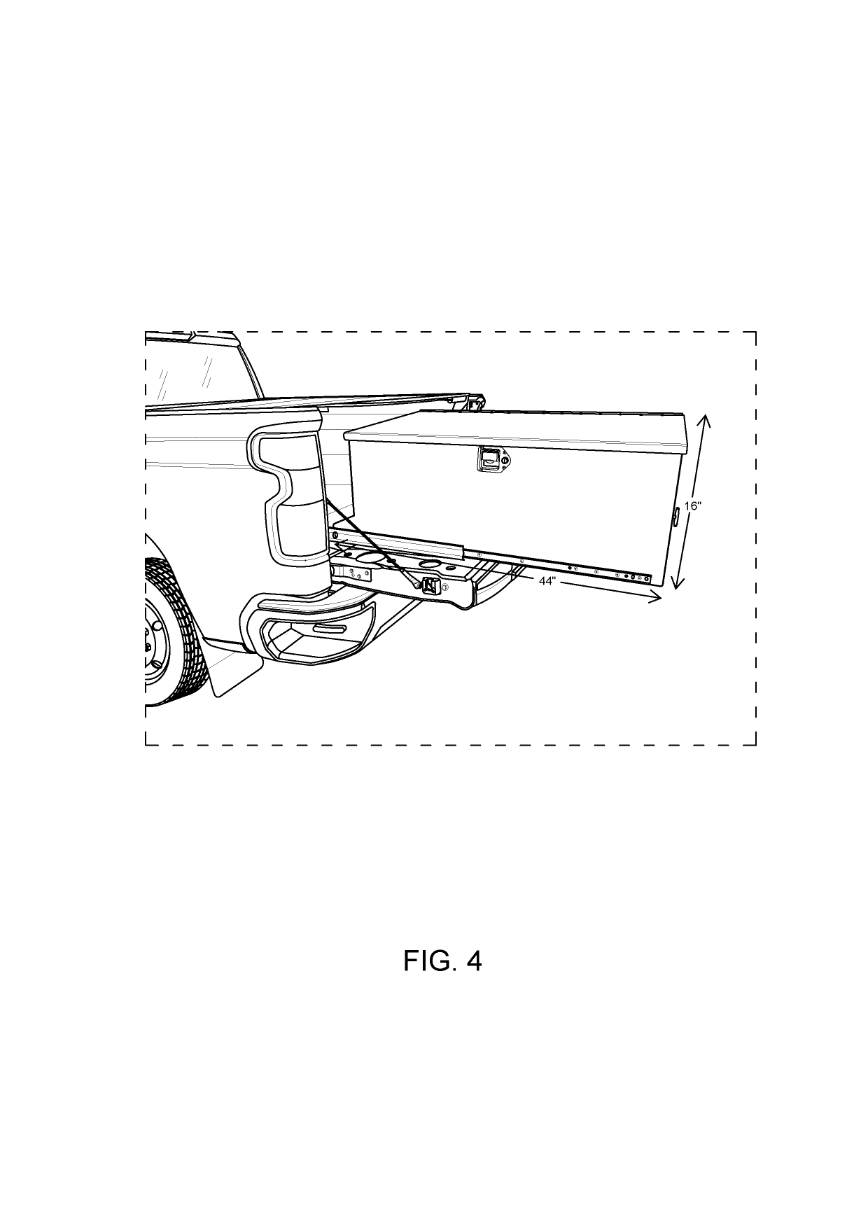

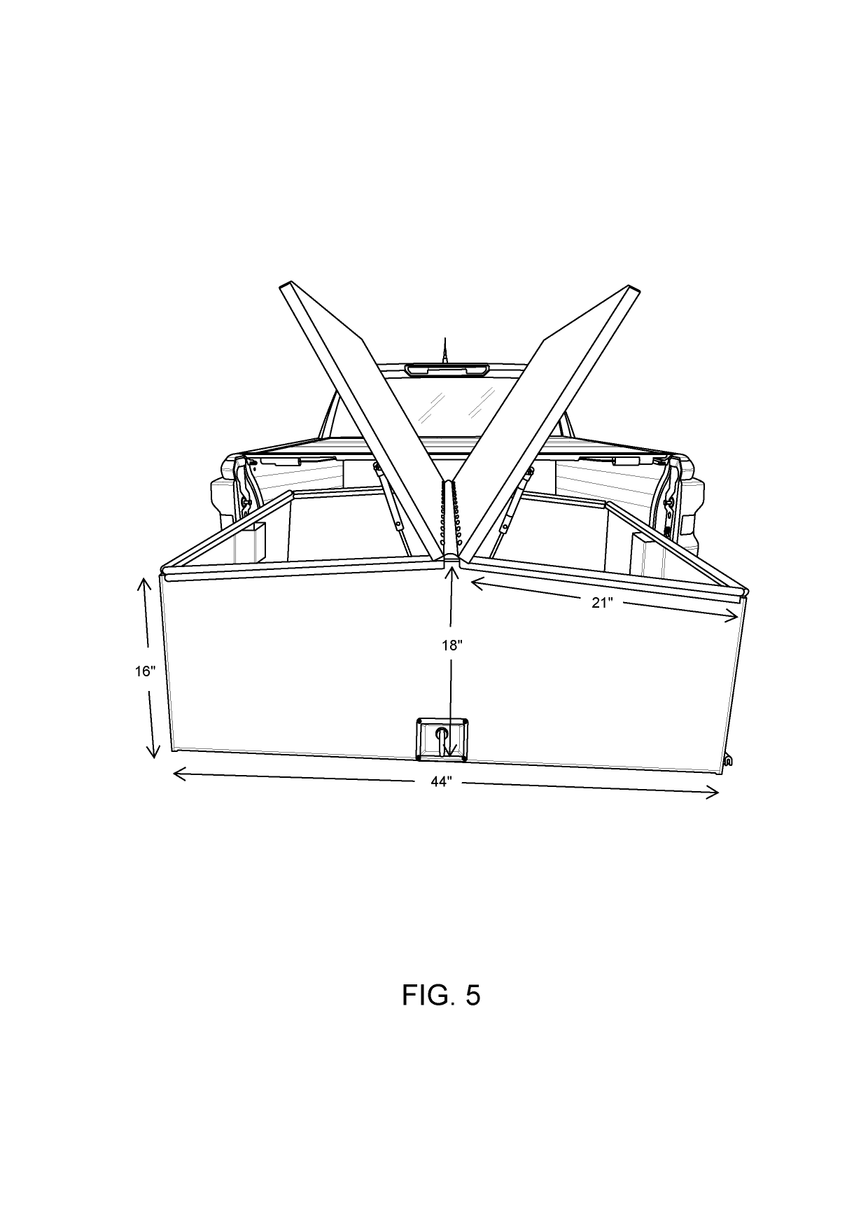

FIGS. 4-5 depict the preferred dimensions of the cargo box, with the measurements being in inches. The angle of the slope of the roof is approximately 10 degrees.

The cargo box can utilize slides attached directly to the sidewalls of the truck bed to support the cargo box. Alternatively the cargo box can be positioned on a platform that is supported by the slides. Potential additions to the cargo box can utilize a lid actuator, such as an electric motor that automatically opens and/or closes one or both of the lids. A cargo box deployment actuator can be utilized to deploy the cargo box and withdraw the cargo box into the truck bed. In either actuator configuration one or more controllers can be utilized to selectively actuate the actuators. The cargo box can be provided with internal dividers, compartments or other organizational components to facilitate organization within the cargo box.

Still other features and advantages of the presently disclosed and claimed inventive concept(s) will become readily apparent to those skilled in this art from the following detailed description describing preferred embodiments of the inventive concept(s), simply by way of illustration of the contemplated embodiments carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

1. A storage system for a bed of a pickup comprising:
a cargo box having a ridgeline, said ridgeline extending a length of said cargo box, said cargo box having cargo box sidewalls having a height lower than said ridgeline, said cargo box defining a storage compartment;
two lids hingedly attached to said ridgeline and extending to said cargo box sidewalls, said lids providing openable access to said compartment from each side of said cargo box;
two slides supporting said cargo box and configured to attach to the bed of a pickup truck, said slides configured for sliding of said cargo box from fully within said bed of said pickup truck to fully out of said bed of said pickup truck.

2. The storage system of claim 1 wherein each of said slides is attached to one of said sidewalls.

3. The storage system of claim 1 wherein the box is configured to be a height less than the sidewalls of the pickup bed so as to fit under a tonneau cover attached to a top of the truck bed.

4. The storage system of claim 1 further comprising a handle on a rear of said box configured for a user to grasp the handle to slide the box out of the bed of the pickup.

5. The storage system of claim 1 wherein said sidewalls are parallel to said ridgeline.

6. The storage system of claim 1 wherein each of said lids is releasably secured to the respective sidewall by a latch.

7. The storage system of claim 3 wherein said latch comprises a lock to lock the lid closed.

8. The storage system of claim 1 wherein said lids are hingedly attached to said ridgeline by at least one piano hinge.

9. The storage system of claim 1 wherein said storage system comprises a strut to hold one of said lids in an open position.

10. The storage system of claim 1 wherein said at least one strut comprises two struts arranged to hold said lids in an open position.

11. A cargo carrier comprising:
an cargo box including fittings configured to slideably couple the cargo box to a truck bed such that the cargo box is configured to slide from a stowed position fully within the cargo box to a deployed position in which the cargo box is positioned fully outside of said truck bed;
wherein cargo box having a ridgeline, said ridgeline extending a length of said cargo box, said cargo box having cargo box sidewalls having a height lower than said ridgeline and two lids hingedly attached to said ridgeline and extending to said sidewalls such that said lids extend at a sloped angle when closed and are configured to rotate open to provide access from either side of said cargo box to an interior of said cargo box.

12. The cargo carrier of claim 11 wherein said fittings comprise two slides supporting said cargo box.

13. The cargo carrier of claim 11 further comprising an actuator to actuate said cargo box to slide from said stowed position to said deployed position.

14. The cargo carrier of claim 13 wherein said actuator is a manual actuator.

15. The cargo carrier of claim 14 wherein said manual actuator is a handle.

16. The cargo carrier of claim 11 wherein said lids are hingedly attached to said ridgeline by a piano hinge.

17. The cargo carrier of claim 11 wherein at least one of said lids comprises a latch for latching the lid in a closed position.

18. The cargo carrier of claim 11 wherein said cargo carrier is installed in the pickup truck bed.

19. The cargo carrier of claim 11 wherein said cargo carrier comprises a height configured to fit below the sidewalls of the pickup truck bed.
